(19) United States
(12) Patent Application Publication
(10) Pub. No.: US 2026/0076782 A1
(43) Pub. Date: Mar. 19, 2026

(54) Improved Abutment System for a Dental Implant and Its Associated Method of Installation and Use

(71) Applicant: Shu Dental Laboratory, Inc., Morrisville, PA (US)

(72) Inventor: Roy Shu, Morrisville, PA (US)

(21) Appl. No.: 18/889,287

(22) Filed: Sep. 18, 2024

(51) Int. Cl. A61C 8/00

(52) U.S. Cl. CPC A61C 8/0068

(57) ABSTRACT

A system and method for implanting a prosthetic tooth in a patient having an intraoral tooth gap. The gingival tissue in the tooth gap is opened to expose a section of jawbone. An implant root is installed into the jawbone. An improved abutment is attached to the implant root. The improved abutment has a cylindrical body. The improved abutment extends a first height above the tooth implant and into the tooth gap. The gingival material is closed around the improved abutment to enable the gingival material to form and heal around the improved abutment. The improved abutment is mapped in the tooth gap to produce a dimensional map, wherein the known dimensions of the improved abutment provide scale to the dimensional map. An implant crown is fabricated using the dimensional map.

### BACKGROUND OF THE INVENTION

### 1. Field of the Invention

In general, the present invention relates to the various attachments that are connected to dental implant roots at different times during the overall dental implant procedure. More particularly, the present invention relates to the structure of gingival healing abutments and scan heads that are selectively attached to a dental implant root.

### 2. Prior Art Description

Dental implants are commonly used for the dental restoration of a partially or wholly edentulous patient. Providing a patient with a dental implant is a multistage process that is completed over a period of months. To start the process, an incision is made through the gingiva to expose the underlying bone. If the old tooth is present, the tooth is removed. A dental implant root is set into the jawbone for osseointegration. The dental implant root generally includes a threaded bore to receive a retaining screw for holding various mating components in later procedures.

The regeneration of bone around the implant typically takes months. To prevent infection and other complications during this time, the gum tissue overlying the implant is traditionally sutured closed. Once the osseointegration process is complete, the patient returns to the dentist and the gingival tissue is re-opened to expose the top of the dental implant root. A component called a healing abutment is fastened to the exposed end of the dental implant to allow the gingival tissue to heal and form around the healing abutment. The healing abutment traditionally has a hexagonal head so that it can be engaged with a wrenching tool and screwed into the bore of the dental implant. The hexagonal head has salient points that cause many patients to continuously touch the healing abutment with their tongues. This can cause cuts on the tongue and irritation in the gingival tissue surrounding the healing abutment.

It should be noted that depending upon the preferences of the dental professional performing the procedure, the healing abutment can be placed on the dental implant immediately after the implant has been installed and before osseointegration. With the implant anchored to the bone and the gingiva tissue healed, an implant crown can be properly fitted to the patient's mouth. To fit the implant crown, an intraoral scan is typically performed. After the gingiva has formed around the healing abutment, the healing abutment is removed, and a scan head is attached to the implant in its place. The scan head has features of known dimensions that are used to scale the scan data and determine the orientation and dimensional requirements of the implant crown. Accordingly, once the scan head and the surrounding teeth and tissue are scanned, a properly fitted implant cap can be fabricated in a lab. This can take several weeks. Once the implant crown is fabricated, the scan head is removed, and the implant crown is affixed to the implant root.

In the prior art, attempts have been made to simplify and shorten the overall dental implant procedure. For example, in U.S. Patent Application Publication No. 2013/0196290 to Herrington, a system is shown where a scan head can be directly attached over the healing abutment. In this manner, the healing abutment need not be removed prior to scanning. This enables scans to be produced before the osseointegration period ends. This enables the implant cap to be manufactured during the osseointegration period so that the implant cap is ready for installation when the osseointegration period is complete.

Although the Herrington system does shorten the overall time it takes to complete a dental implant procedure, there are disadvantages. By attaching the scanning head to the healing abutment prior to the completion of osseointegration, there may be tissue that has grown over the healing abutment. This is a common occurrence. The excess tissue must be cut way, which can cause inflammation. Furthermore, although the scan head mounts over the healing abutment, the healing abutment remains. The healing abutment has salient points which may cause tongue and tissue irritation. All such irritation and inflammation is captured by the scan and can result in an implant crown being manufactured that does not properly fit.

A need therefore exists for an improved healing abutment system that removes the salient points embodied in prior art healing abutments. A need also exists for an improved healing abutment that can be directly scanned, therein removing the need for a separate scan head, and resulting in a simplified and shortened implantation procedure. These needs are met by the present invention as described and claimed below.

### SUMMARY OF THE INVENTION

The present invention is a system and method for implanting a prosthetic tooth in a patient having an intraoral tooth gap. The gingival tissue in the tooth gap is opened to expose a section of jawbone. An implant root is then installed into the jawbone. The implant root has a threaded bore that is formed around a first centerline.

An improved abutment is attached to the implant root. The improved abutment has a cylindrical body that is formed around a second centerline. The improved abutment extends a first height above the tooth implant and into the tooth gap, with the second centerline being concentrically aligned with the first centerline.

The gingival material is closed around the improved abutment to enable the gingival material to form and heal around the improved abutment in the tooth gap. The improved abutment is mapped in the tooth gap to produce a dimensional map, wherein the known dimensions and orientation of the improved abutment provide scale and orientation to the dimensional map.

An implant crown is fabricated in a lab using the dimensional map. Once the implant crown is ready, the improved abutment is removed and the implant crown is attached to the implant root.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a block diagram illustrating the steps used in performing a tooth implantation procedure in accordance with the present invention;

FIG. 2 illustrates some steps used in the implantation procedure outlined in FIG. 1;

FIG. 3 is an exploded cross-sectional view of an improved abutment shown in conjunction with an implant root and connecting screw;

FIG. 4 shows a cross-sectional view of an improved abutment, implant root and connecting screw set into a jaw bone and surrounded by gingival tissue;

FIG. 5 shows a side view of a first exemplary embodiment of an improved abutment;

FIG. 6 shows a top view of the exemplary embodiment of FIG. 5;

FIG. 7 shows a side view of a second exemplary embodiment of an improved abutment; and

FIG. 8 shows a top view of the exemplary embodiment of FIG. 7;

FIG. 9 illustrates some of the final steps used in the implantation procedure outlined in FIG. 1.

### DETAILED DESCRIPTION OF THE DRAWINGS

Although the present invention system and method can be embodied in many ways, only two exemplary embodiments are illustrated. The exemplary embodiments are being shown for the purposes of explanation and description. The exemplary embodiments are selected in order to set forth some of the best modes contemplated for the invention. The illustrated embodiments, however, are merely exemplary and should not be considered as limitations when interpreting the scope of the claims.

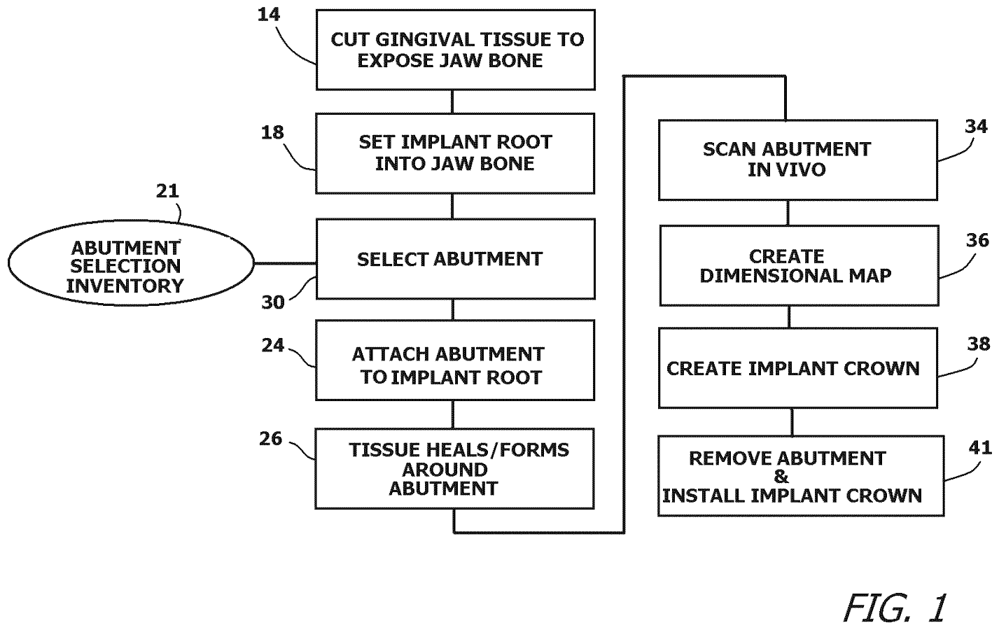

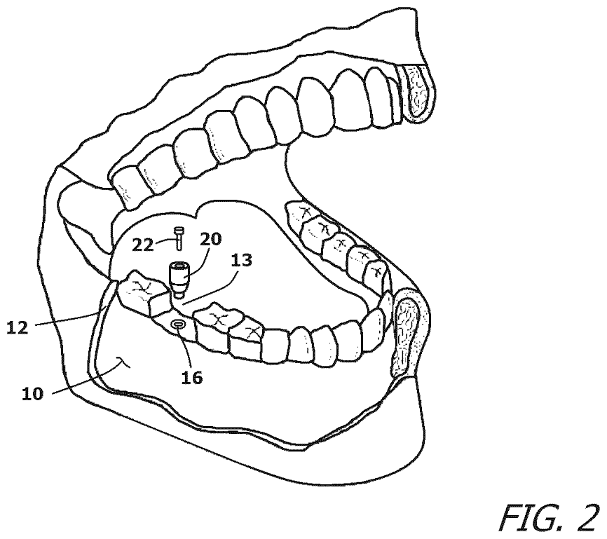

Referring to FIG. 1 in conjunction with FIG. 2, it can be seen that in a traditional initial step of a dental implant procedure, the gingival tissue 12 is cut in a tooth gap 13 to expose the jaw bone 10. If a diseased tooth is present it is removed. See Block 14. The jaw bone 10 is prepared and an implant root 16 is set into the jaw bone 10 within the tooth gap 13. See Block 18.

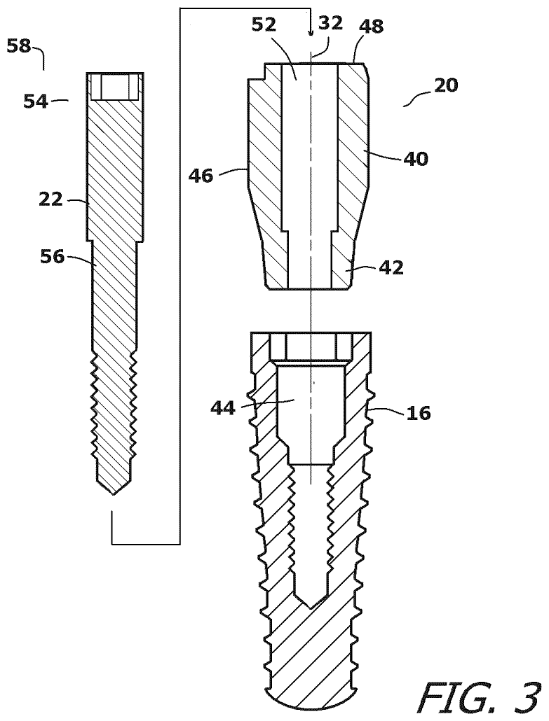

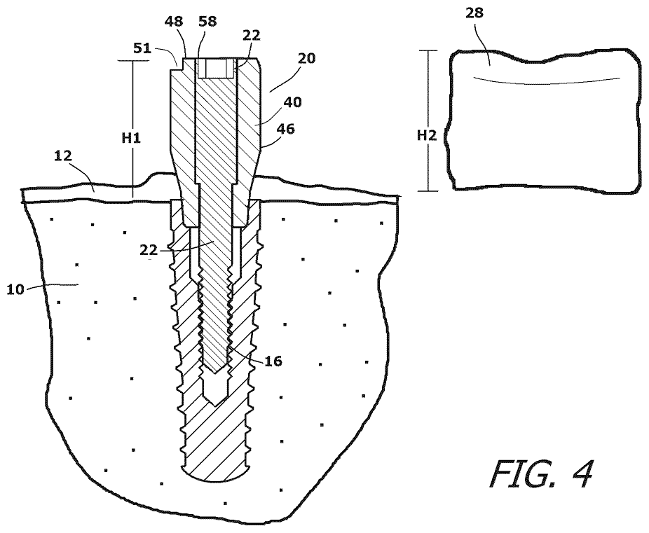

Referring to FIG. 3 and FIG. 4 in conjunction with FIG. 1 and FIG. 2, it can be seen that an improved abutment 20 is selected from an existing inventory 21. An improved abutment 20 is selected that is appropriate for the prosthetic tooth being implanted. The improved abutment 20 is attached to the implant root 16 with a screw 22. See Block 24. The gingival tissue 12 is sutured around the improved abutment 20 so that the gingival tissue 12 heals and forms around the improved abutment 20. See Block 26. The healing of the gingival tissue 12 occurs at the same time that the implant root 16 becomes anchored through osseointegration. At the end of the osseointegration period, the implant root 16 is integrated into the jaw bone 10 and the gingival tissue 12 has formed and healed around the improved abutment 20. As such, the patient is ready for installation of an implant crown 28 as soon as the osseointegration period ends.

The improved abutment 20 serves two functions. The improved abutment 20 acts as a traditional healing abutment, where it protects the implant root 16 and enables the gingival tissue 12 to regrow into the proper shape. The improved abutment 20 also serves as a scan head. The improved abutment 20 extends above the implant root 16 to a height H1 above the implant root 16. The height H1 is preferably between fifty percent and seventy-five percent the height H2 of the full implant crown 28 that will be installed. In this manner, the improved abutment 20 will not extend beyond the height of adjacent teeth where it can be stressed by biting and chewing during osseointegration. The improved abutment 20 is selected from a large selection of shapes and sizes. See Block 30. Each improved abutment 20 has features of known dimensions that have a high degree of precision. The improved abutment 20 is attached to the implant root 16. A dimensional map 35 is created by scanning and/or taking an impression of the improved abutment 20 in the tooth gap 13. See Block 34 and Block 36.

Each improved abutment 20 has a centerline 32 that aligns with the centerline of the implant root 16. As such, when an improved abutment 16 is attached to an implant root 16, the improved abutment 16 acts as extension to the implant root 16 and embodies the inclination angles and orientation of the implant root 16. Thus, by scanning the dimensions and inclinations of the improved abutment 20, the position, orientation and inclinations of the underlying implant root 16 become known. Furthermore, since the dimensions of the improved abutment 20 are known, any scan or impression containing the improved abutment 20 can be precisely scaled.

Referring to FIG. 4 in conjunction with FIG. 3, it can be seen that each improved abutment 20 has a tubular body section 40 that extends into a reduced neck section 42. The tubular body section 40 and reduced neck section 42 are preferably machined from a single piece of material. The preferred material is titanium. However, other non-reactive materials can be used. The reduced neck section 42 of the improved abutment 20 is shaped and sized to engage any countersink depression 44 present in the implant root 16. Depending upon the make and model of the implant root 16, the implant root 16 may not have a countersink depression 44. In such a case, an improved abutment 20 can be provided that does not have a reduced neck section 42.

The tubular body section 40 of the improved abutment 20 is preferably cylindrical with a smooth outer surface 46 and a top surface 48. A dimensional feature 51 is formed at the interface between the smooth outer surface 46 and the top surface 48. Otherwise, there is an edge 50 between the outer surface 46 and the top surface 48 is rounded. The outer surface 46 and the top surface 48 can be felt by the tongue inside the mouth. By providing a tubular body section 40 with no sharp edges or salient points, a patient will not aggravate their tongue by rubbing against the improved abutment 20.

The tubular body section 40 of the improved abutment 20 defines an internal bore 52. The internal bore 52 is sized to receive the head 54 and shaft 56 of the mounting screw 22. The mounting screw 22 passes through the internal bore 52 and threads into the implant root 16. When engaged with the tubular body section 40 of the improved abutment 20, the top 58 of the mounting screw 22 lay flush with the top surface 48 of the tubular body section 40. The diameter D1 of the tubular body section 40 has a known dimension and is at least as large as the diameter of the implant root 16. Tubular bodies of different known diameters can be used depending upon the position and size of the missing tooth being replaced. For example, a larger improved abutment 20 would be used in the place of a molar than would be used in the place of an incisor.

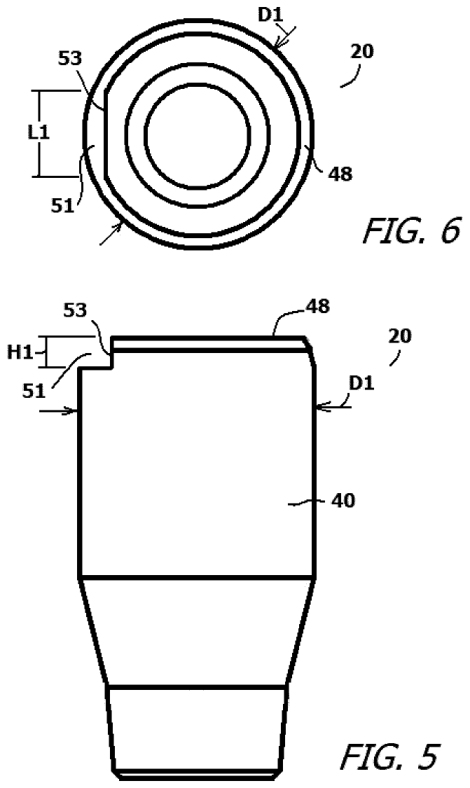

Referring to FIG. 5 in conjunction with FIG. 6, it can be seen that the outer diameter D1 of the tubular body section 40 has a known dimension. The dimension is typically 4 mm, 5 mm, 6 mm, 7 mm, or 8 mm, depending upon intended use. In addition to the outer diameter D1, other dimensional features 51 can be used to determine the orientation of the improved abutment. In the illustrated embodiment, the dimensional feature 51 is a step cut into the tubular body section 40 just below the top surface 48. The dimensional feature 51 has a straight rear wall 53 of a known height H1 and length L1. The straight rear wall 53 can therefore be used to determine the overall orientation of the improved abutment 20 as well as secondary scale reference for scaling images that show the dimensional feature.

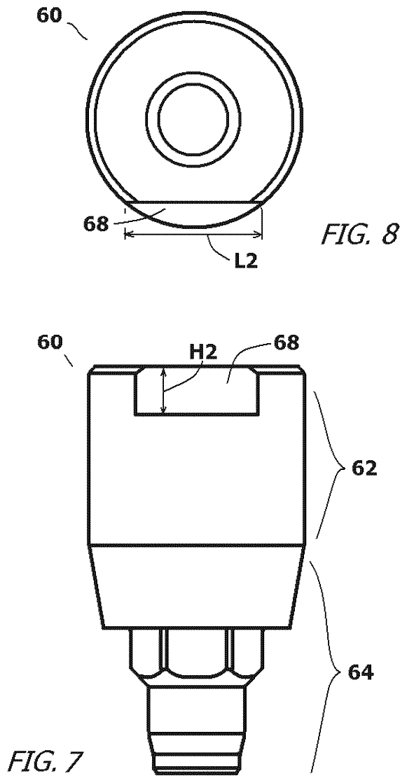

Referring to FIG. 7 and FIG. 8, an alternate embodiment of an improved abutment 60 is shown. In this embodiment, the improved abutment 60 is larger than that of the previous embodiment. This larger improved abutment 60 is for use in the replacement of larger teeth, such as molars.

The improved abutment 60 has a tubular body section 62, a reduced neck section 64, and a tapered section 66 that is disposed between the tubular body section 62 and the reduced neck section 64. The tubular body section 62 has a diameter D2 of 5 mm or larger. At least one dimensional features 66 is also provided. The dimensional feature 66 includes a step cut into the tubular body section 62. The dimensional feature 66 has a straight rear wall 68 of a known height H2 and length L2. The straight rear wall 68 can therefore be used to determine the overall orientation of the improved abutment 60 as well as secondary scale reference for scaling images that show the dimensional feature.

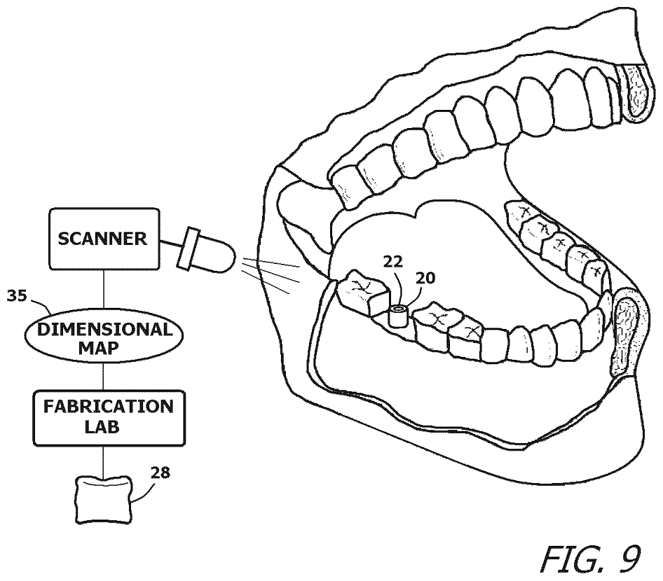

Referring to FIG. 9 in conjunction with FIG. 1, it will be understood that the improved abutment 20 can be connected to the implant root 16 at the time of implantation. As soon as swelling from implantation recedes, the intraoral cavity can be mapped using an intraoral scan and/or a molded impression. See Block 34. If no swelling is present, the scan/impression can be made at the end of the implantation procedure. After implantation, the osseointegration period begins. This period typically lasts at least three months. A dimensional map 35 is created using data from a scan or impression. The scan and/or impression is scaled using the dimensions and dimensional features of the improved abutment 20. The dimensional map 35 is used to fabricate the custom implant crown 28. See Block 38. The fabrication of the implant crown 28 preferably occurs during the osseointegration period. As a result, when the osseointegration period ends, the improved abutment 20 can be quickly removed and the implant crown 28 installed. See Block 41. This completes the overall implant process. The removed improved abutment 20 can be autoclaved and stored for reuse.

It will be understood that the embodiments of the present invention that are illustrated and described are merely exemplary and that a person skilled in the art can make many variations to those embodiments. All such embodiments are intended to be included within the scope of the present invention as defined by the appended claims.

What is claimed is:

1. In a patient having an intraoral tooth gap, a method of implanting a prosthetic tooth into said tooth gap, comprising the steps of:
opening gingival tissue in said tooth gap and exposing a section of jawbone;
installing an implant root into said jawbone, wherein said implant root has a threaded bore formed around a first centerline;
providing a hybrid abutment that serves both as a healing abutment and a scan head, wherein said hybrid abutment has a dimensional features and a cylindrical body formed around a second centerline;
attaching an improved abutment to said implant root, wherein said hybrid abutment extends a first height above said implant root and into said tooth gap, with said second centerline being concentrically aligned with said first centerline;
closing said gingival tissue around said hybrid abutment to enable said gingival tissue to form and heal around said hybrid abutment in said tooth gap;
mapping said hybrid abutment in said tooth gap to produce a dimensional map, wherein said hybrid abutment provides scale to said dimensional map;
fabricating an implant crown using said dimensional map; and
removing said hybrid abutment and attaching said implant crown to said implant root.

2. The method according to claim 1, wherein said hybrid abutment has a bore formed therethrough, wherein attaching said hybrid abutment to said implant root includes passing a screw into said bore and attaching said hybrid abutment to said implant root with said screw.

3. The method according to claim 2, wherein said cylindrical body has a first top surface and said screw has a second top surface, wherein said second top surface of said screw lay flush with said first top surface of said cylindrical body when said screw attaches said hybrid abutment to said implant root.

4. The method according to claim 1, wherein said implant crown has a crown height and said first height of said hybrid abutment is between fifty percent and seventy five percent of said crown height.

5. The method according to claim 1, wherein said mapping said hybrid abutment in said tooth gap includes scanning said hybrid abutment in said tooth gap.

6. The method according to claim 1, wherein said mapping said hybrid abutment in said tooth gap includes taking an impression of said hybrid abutment in said tooth gap.

7. A method of implanting a prosthetic tooth into a tooth gap, comprising the steps of:
opening gingival tissue in said tooth gap and exposing a section of jawbone;
installing an implant root into said jawbone;
attaching a hybrid abutment to said implant root, wherein said hybrid abutment has a cylindrical body, and wherein said hybrid abutment extends a first height above said implant root and into said tooth gap;
scanning said hybrid abutment in said tooth gap to produce a dimensional map, wherein said hybrid abutment provides scale to said dimensional map;
fabricating an implant crown using said dimensional map; and
removing said hybrid abutment and attaching said implant crown to said implant root.

8. The method according to claim 7, wherein attaching said hybrid abutment to said implant root includes passing a screw through said hybrid abutment and into said implant root.

9. The method according to claim 8, wherein said cylindrical body has a first top surface and said screw has a second top surface, wherein said second top surface of said screw lies flush with said first top surface of said cylindrical body when said screw attaches said hybrid abutment to said tooth root.

10. The method according to claim 7, wherein said implant crown has a crown height and said first height of said hybrid abutment is between fifty percent and seventy five percent of said crown height.
